(19) United States
(12) Patent Application Publication
(10) Pub. No.: US 2009/0048993 A1
(43) Pub. Date: Feb. 19, 2009

(54) IMPLEMENTATION OF OPERATING SYSTEM SECURING

(75) Inventors: Jeffrey G. Lohrbach, Elgin, IL (US); Lewis J. Muhlenkamp, Palatine, IL (US); Jonathan F. Reed, Crystal Lake, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/837,695

(22) Filed: Aug. 13, 2007

(51) Int. Cl. G06N 5/02

(52) U.S. Cl. 706/45

(57) ABSTRACT

A method (200, 300) of securing an operating system. The method can include, for a first application to be instantiated on the operating system, receiving from a first security template (106) at least a first recommended value for a configuration line item. The method also can include, for a second application to be instantiated on the operating system, receiving a second security template at least a second recommended value for the configuration line item. From among at least the first and second values, at least one value that is compatible with each of the applications can be selected. Further, an output (120) can be generated that automatically updates the configuration line item with the selected at least one value.

### BACKGROUND OF THE INVENTION

1. Field of the Invention

The present invention generally relates to operating systems and, more particularly, to operating system security.

2. Background of the Invention

Presently, software security is at the forefront of computer related issues. Throughout the evolution of networking and the Internet, threats to the security of operating systems and applications have risen dramatically. Indeed, it is estimated that security breaches now cost the global economy tens of billion of dollars annually and the costs continue to grow. The hardening of software, especially operating systems, has therefore become very critical to modern day computing.

A variety of standards have been developed to define suitable methods of hardening operating systems against security threats. One example of such a standard is the Defense Information Systems Agency (DISA) Security Technical Implementation Guide (STIG). Implementation of a hardening standard typically requires the modification of many individual operating system settings. These modifications are sometimes implemented using manually created configuration scripts.

The modifications are not always compatible with all of the applications that are going to be instantiated on a hardened operating system. Thus, after default hardening of the operating system has been completed, additional configuration changes are often required for each of the applications that will be executed. Moreover, conflicts among such configuration changes also must be identified and resolved. Thus, proper hardening of an operating system generally requires a significant effort.

### SUMMARY OF THE INVENTION

The present invention relates to a method of securing an operating system. For a first application to be instantiated on the operating system, at least a first recommended value for a configuration line item can be received from a first security template. For a second application to be instantiated on the operating system, at least a second recommended value for the configuration line item can be received from a second security template. From among at least the first and second values, at least one value that is compatible with each of the applications can be selected. Further, an output can be generated that automatically updates the configuration line item with the selected at least one value.

In another arrangement, a plurality of recommended values for a particular configuration line item of the operating system can be received. A suitable one of the plurality of recommended values can be selected based on security implementation rules. Further, an output can be generated that automatically updates the configuration line item with the selected value.

The present invention also relates to a computer program product including a computer-usable medium having computer-usable program code that, when executed, causes a machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a system for automating the process of securing an operating system, which is useful for understanding the present invention;

FIG. 2 is a flowchart that is useful for understanding the present invention; and

FIG. 3 is another flowchart that is useful for understanding the present invention.

### DETAILED DESCRIPTION

The present invention may take the form of an entirely hardware embodiment, an entirely software embodiment, including firmware, resident software, micro-code, etc., or an embodiment combining software and hardware aspects that may all generally be referred to herein as a “circuit,” “module,” or “system.”

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, magneto-optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

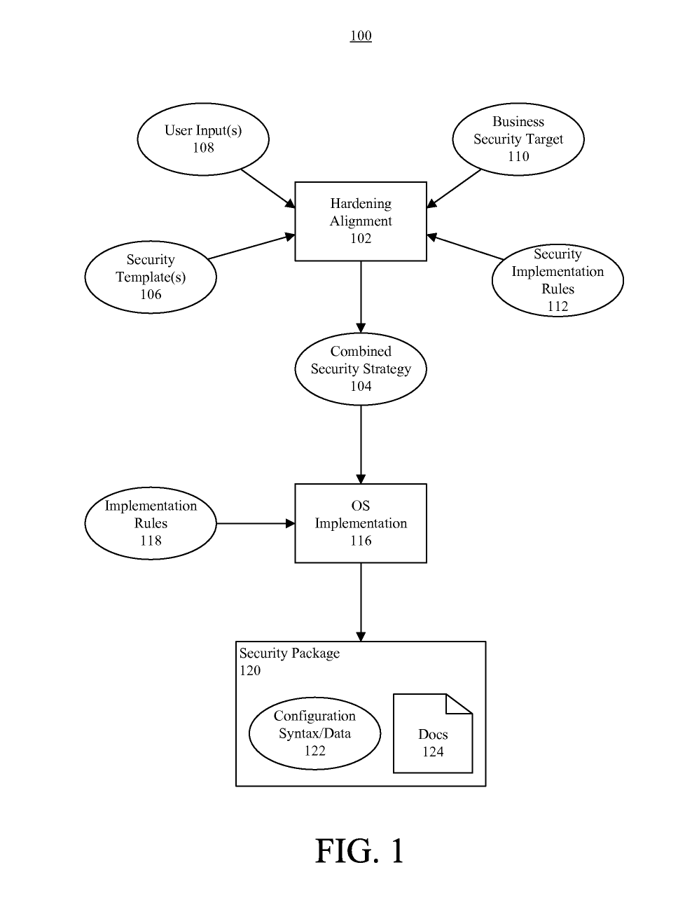

FIG. 1 depicts a system 100 for automating the process of securing an operating system (OS) that executes on a data processing system (hereinafter “processing system”). The system 100 can include a hardening alignment module 102 that receives a variety of data inputs and processes such inputs to generate a combined security strategy 104 for the OS. The combined security strategy 104 can indicate one or more configuration parameters to be implemented on the OS that are compatible with a plurality of applications that may be instantiated. In one arrangement, the combined security strategy 104 can indicate the complete set of decisions for each configuration line item of the OS.

As used herein, the term “configuration line item” means a particular system configuration option that may be set to a particular value. A configuration line item can correlate to software configuration and/or to hardware configuration. As used herein, the term “value” means any indicator that may be used to set a configuration line item. For example, a value can comprise one or more ASCII characters, one or more alphanumeric characters, one or more binary characters, one or more hexadecimal characters, one or more flags, or any other means for indicating a recommended setting for a configuration line item. One approach that may be implemented for securing an OS is to set all configuration line items to their maximally secured values, then selectively update the configuration line items as described herein.

The configuration parameters can correspond to file permissions, operational behaviors, and the like. For example, if a first application is tolerant of a very high security value for a particular configuration parameter, but a second application requires a lower security value for proper operation, the combined security strategy 104 can indicate that the lower security value is to be implemented for the configuration parameter. Accordingly, both the first and second applications can be properly executed on the OS without a security conflict.

The data inputs received by the hardening alignment module 102 can include one or more security templates 106, user inputs 108, business security targets 110 and/or security implementation rules 112. The data inputs can be provided in any suitable format. For example, one or more of the user inputs 108 and business security targets 110 can be provided as scripts, executable files, such as information (.inf) files or registry data (.reg) files, or text files, for instance Extensible Markup Language (XML) files. Data may be parsed from such files as necessary. For example, a parser (not shown) can be provided to parse information from input files. The security implementation rules 112 can be provided as algorithms, for instance within text files, XML files, data files, etc., or as a file or data type that identifies a suitable algorithm.

The security templates 106 can comprise recommended values for OS configuration line items. One or more of the security templates 106 can be associated with respective applications that may be instantiated on the OS, and can be based on the requirements of such applications, for instance security requirements. Such configuration recommendations can be applicable to system functions, system layers, and/or any other aspects of the processing system. For example, the security templates 106 can include numeric values that indicate security levels, indicators that indicate system features to enable and/or disable, indicators that indicate system resources to enable and/or disable, indicators that indicate system access limitations, indicators that indicate suitable password formats, and so on. In one arrangement, the security templates 106 can be based on one or more security standards. Examples of such standards can include, but are not limited to, Defense Information Systems Agency (DISA) Security Technical Implementation Guides (STIGs).

The user inputs 108 can include user selected configuration values. Such values can be application specific, layer specific, or correlate to any other aspects of securing the processing system. The user inputs 108 can be entered by a system administrator, a person tasked with configuring the OS, or any other authorized user. The user inputs can be specific to a particular system or group of systems, but the invention is not limited in this regard.

The business security target 110 can include business wide recommended values for configuration line items. For example, certain configuration line items may not be addressed by the security templates 106, but nonetheless are important to a particular business or type of business. Such configuration line items, as well as recommended values for such configuration line items, can be identified by the business security target 110. Further, values recommended by the security templates 106 for certain configuration line items may not be commensurate with other system requirements. These configuration line items also can be identified by the business security target 110, and the business security target 110 can recommend suitable values that may be selected for such configuration line items.

Security implementation rules 112 can be accessed by the hardening alignment module 102 and processed in order to select values for the OS configuration line items that are compatible with one or more applications that may be instantiated on the OS. In that regard, the security implementation rules 112 can provide one or more algorithms for selecting suitable values in instances in which one or more of the security templates 106, user inputs 108 and/or the business security target 110 differ or conflict with respect to their recommended values. For example, the security implementation rules 112 can prioritize such inputs 106-110. In one arrangement, the security implementation rules 112 that are used by the hardening alignment module 102 at any particular time can be selected based upon the security template(s) 106, the user input(s) 108, the business input(s) and/or the business security target 110.

In one aspect of the inventive arrangements, the security implementation rules 112 can give precedence to one or more of the security templates 106, user inputs 108 and business security target 110. Such inputs 106-110 can be prioritized in any suitable manner. For example, the security implementation rules 112 can categorize the various types of inputs 106-110 into hierarchical layers. For example, the user inputs 108 can be assigned a first or highest level of priority, while the business security target 110 can be assigned a second level of priority, and the security templates 106 can be assigned a third level of priority.

Thus, if the business security target 110 is categorized higher in the hierarchy than the security templates 106 (e.g. has higher priority), and a conflict is identified between a security template 106 and the business security target 110, the security implementation rules 112 can indicate to the hardening alignment module 102 to give precedence to the business security target 110 by selecting its recommended value for the configuration line item. A user can be provided user configurable options to consolidate one or more of the hierarchical layers, eliminate the hierarchical layering scheme, re-prioritize the inputs 106-110, or override value selections.

The security implementation rules 112 may comprise more complex algorithms that may be processed to resolve such differences and/or conflicts among the inputs 106-110. By way of example, an algorithm may indicate to the hardening alignment module 102 to select a value that provides the greatest level of available OS security that is compatible with each of the inputs 106-110. For instance, if a first security template 106 recommends that a particular system resource should be unavailable to system processes, but a second security template 106 indicates that the system resource should be available when a particular function is executed, an applicable algorithm may indicate that the system resource is to be available in accordance with the indication of the second security template 106.

In some instances differences or conflicts between two or more security templates 106 may not be able to be resolved using the security implementation rules 112. In such case the hardening alignment tool can generate a conflict indicator. The conflict indicator can be included in the combined security strategy 104 or generated in another form of output. For example, a conflict message can be presented to a user, added to a conflict log, or output in any other suitable manner.

The hardening alignment module 102 can communicate the combined security strategy 104 to an OS implementation module 116, which may process the combined security strategy 104 in accordance with OS implementation rules 118 to generate an output comprising a security package 120 optimized for a desired OS. The OS implementation rules 118 can be processed to map configuration values in the combined security strategy 104 to specific configuration line items in the OS that are to be updated with the values. For instance, the implementation rules 118 can provide syntax and/or data that correlate to setting or updating configuration line items with selected configuration values. Thus, if the combined security strategy 104 indicates a first port is to remain closed, the OS implementation module 116 can process the implementation rules 118 to generate appropriate syntax and/or data that may be used in the OS to close the first port. The OS implementation module 116 can include such syntax or data in the security package 120.

Because the security package 120 may be generated based on multiple data inputs 106-112, the security package 120 need not be limited by any one of the data inputs 106-112. For instance, the security package 120 can specify values for configuration line items identified by security templates 106 as well as values for configuration line items identified by user inputs 108.

In one arrangement, the OS implementation rules 118 can comprise a plurality of syntax/data templates, each of which corresponds to one or more configuration line items that potentially may be set in accordance with the combined security strategy 104. In another arrangement, the OS implementation rules 118 can comprise one or more data tables or data files which include a plurality of records, each of which corresponds to one or more of the configuration line items. Still, the OS implementation rules 118 can be implemented in any other suitable manner and the invention is not limited in this regard.

The security package 120 can comprise syntax and/or data 122 suitable for configuring the OS in accordance with the combined security strategy 104 and the implementation rules 118. For instance, the syntax and/or data 122 can comprise one or more text files, data files, executable files, scripts, etc. There need not be a one-to-one correspondence between configuration line items and such syntax and/or data 122. For example, some files or scripts may correspond to a single configuration line item, while other files or scripts may correspond to multiple configuration line items. Further, one or more files or scripts can be assembled from constituent script segments, also known as “snippets.” It should be noted that the types of scripts and the parsing rules used by the scripts may differ based on the type of configuration file being modified.

By way of example, if the OS is the Microsoft® Windows® OS, the security package 120 can include one or more information (.inf) files and/or registry data (.reg) files. The information files can be policy templates that provide parameters for suitably configuring line items within various Windows® components and/or applications that may be instantiated on Windows®. The registry data files can provide data that may be processed by a registry editing application (e.g. regedit.exe) to update configuration line items in the OS registry. For example, the registry data file can provide data for importing and exporting registry keys, subkeys and values. In one arrangement, the information file(s) and registry data can be generated using input files in a suitable format, such as XML, although the invention is not limited in this regard. In a further arrangement, the registry data file and/or registry data file can be attached to or referenced by an executable file or script that is generated by the OS implementation module 116. The executable file or script may be executed on a system to automatically update the configuration line items with their selected values.

A single file set comprising one or more output file types (e.g. information file, registry data file, and/or script) including the syntax and/or data 122 portion of the security package 120 may be generated. Such file set can correspond to configuration line items affecting all targeted system layers. Alternatively, multiple syntax and/or data 122 file sets may be generated, each set comprising one or more of the output file types (e.g. information file, registry data files and/or scripts). When multiple syntax and/or data 122 file sets are generated (e.g. multiple information files, registry data files and/or scripts), each of the file sets can correspond to a respective system layer. For instance, a first file set can correspond to configuration line items affecting the application layer, a second file set can correspond to configuration line items affecting the network layer, and so on. In another arrangement, a first file set can correspond to configuration line items affecting default hardening of security settings, a second file set can correspond to configuration line items affecting selective softening of application security settings, and a third file set can correspond to configuration line items affecting selective softening of business wide security settings.

In a further arrangement, the user inputs 108 can identify to which groups of configuration line items the various file sets are to correspond. The user inputs 108 also can indicate whether the system 100 is to generate multiple file sets in the security package 120, or whether to consolidate all configuration line item updates into a single file set within the security package 120.

The present invention is not limited to the Windows® OS. For example, the present invention also may be applicable to UNIX®, Solaris®, Linux®, Mac OS X®, or any other desired OS. In such arrangements, the implementation rules 118 and the security package 120 that is generated can be tailored to the target OS. For example, if the target OS is Solaris®, the OS implementation module 116 can generate textual scripts (e.g. Perl scripts, Shell scripts, etc.), which can parse text-based configuration files, identify and change the appropriate values for the configuration line items, and save the modified text-based configuration files.

As previously noted, there need not be a one-to-one correspondence between configuration line items and the textual scripts. For example, some scripts may correspond to a single configuration line item, while other scripts may correspond to multiple configuration line items. Further, one or more scripts can be assembled from constituent script segments. The types of scripts and the parsing rules used by the scripts may differ based on the type of configuration file being modified.

Examples of modified configuration files for Solaris can include, but are not limited to, /etc/inetd.conf, /etc/passwd, and /etc/shadow. Configuration line items in Unix®, Linux® and Mac OS X® also can be updated with selected values using a series of scripts. By way of example, modified configuration files for Linux® can include, but are not limited to, /etc/sysctl.conf, /etc/passwd, and /etc/shadow.

The security package 120 also can comprise documentation 124 that is automatically generated to identify the configuration settings that are implemented by the configuration syntax/data 122. For instance, the documentation can identify configuration line items that are updated and the values with which they are updated. In particular, configuration line items that are set to values that deviate from the security template(s) 106 and/or the business security targets 110 can be identified. In one arrangement, the documentation 124 can be formatted as certification and accreditation documentation.

Notably, rather than relying on a user to manually develop security policies on an OS, the security package 120 can be automatically generated by the system 100 and processed by the OS to implement suitable security settings. Moreover, the system 100 can automatically implement conflict resolution, as previously described, to insure that the implemented security settings are compatible with all of the applications that are going to be instantiated on the OS.

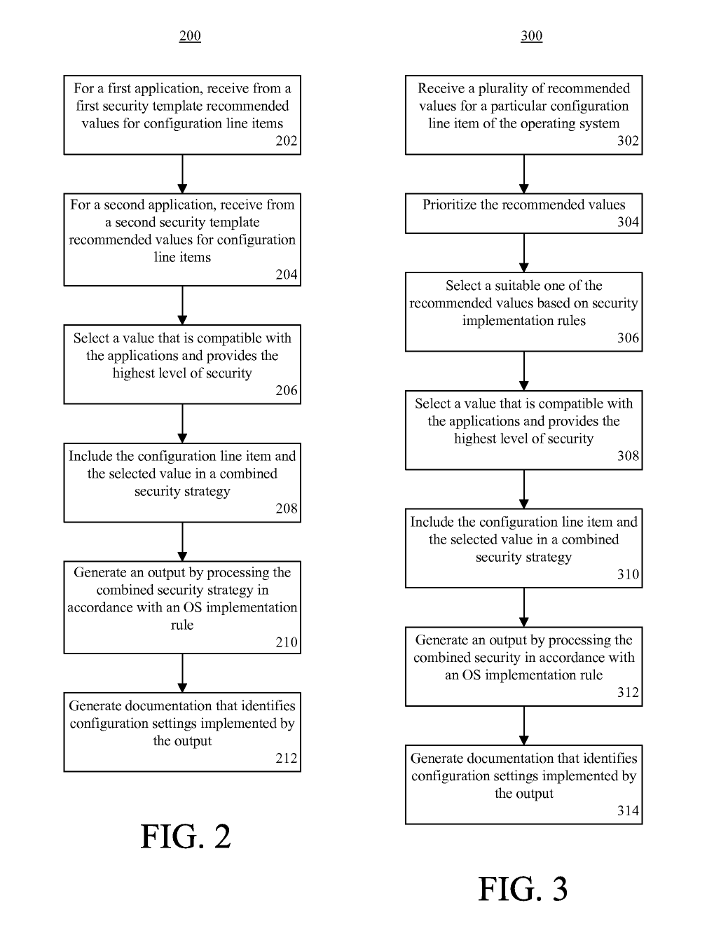

FIG. 2 is a flowchart presenting a method 200 that is useful for understanding the present invention. At step 202, for a first application, recommended values for configuration line items can be received from a first security template and/or a business security target. At step 204, for a second application, recommended values for configuration line items can be received from a second security template. Recommended values for configuration line items also can be received from one or more additional security templates.

At step 206, a value that is compatible with the applications and provides the highest level of security can be selected. At step 208, the selected value and the configuration line item can be combined into a security strategy. Proceeding to step 210, an output can be generated by processing the combined security strategy in accordance with an OS implementation rule. At step 212, documentation that identifies configuration settings implemented by the output can be generated.

FIG. 3 is another flowchart presenting a method 300 that is useful for understanding the present invention. At step 302 a plurality of recommended values for a particular configuration line item of the operating system can be received. At step 304 the recommended values can be prioritized. For instance, the values can be prioritized based on hierarchical layers with which they are associated, as previously described. Continuing to step 306, a suitable one of the recommended values based on security implementation rules can be selected. At step 308 a value that is compatible with the applications and that provides the highest level of security can be selected. At step 310, the selected value and the configuration line item can be combined into a security strategy. Proceeding to step 312, an output can be generated by processing the combined security strategy in accordance with an OS implementation rule. At step 314, documentation that identifies configuration settings implemented by the output can be generated.

The flowchart and system diagram in the figures illustrate the architecture, functionality, and operation of possible implementations of systems, methods and computer program products according to various embodiments of the present invention. In this regard, each block in the flowchart or system diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the system diagram and/or flowchart illustration, and combinations of blocks in the system diagram and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the terms “a” and “an,” as used herein, are defined as one or more than one. The term “plurality,” as used herein, is defined as two or more than two. The term “another,” as used herein, is defined as at least a second or more. The terms “including,” “having,” “comprises” and/or “comprising,” as used herein, specify the presence of stated features, integers, steps, operations, elements, and/or components, but do not preclude the presence or addition of one or more other features, integers, steps, operations, elements, components, and/or groups thereof.

The terms “computer code,” “computer program,” “computer program code,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A method of securing an operating system, comprising:
for a first application to be instantiated on the operating system, receiving from a first security template at least a first recommended value for a configuration line item;
for a second application to be instantiated on the operating system, receiving from a second security template at least a second recommended value for the configuration line item;
from among at least the first and second values, automatically selecting at least one value that is compatible with each of the applications; and
generating an output that automatically updates the configuration line item with the selected at least one value.

2. The method of claim 1, wherein generating the output that automatically updates the configuration line item comprises processing at least one security implementation rule that identifies the configuration line item.

3. The method of claim 1, wherein generating the output that automatically updates the configuration line item comprises generating at least one file selected from the group consisting of an information file and a data registry file.

4. The method of claim 1, wherein generating the output that automatically updates the configuration line item comprises generating at least one script.

5. The method of claim 1, wherein generating the output that automatically updates the configuration line item comprises processing the configuration line item and the selected value in accordance with an implementation rule corresponding to the operating system.

6. The method of claim 1, wherein generating the output that automatically updates the configuration line item comprises generating an executable file.

7. The method of claim 1, wherein selecting the at least one value comprises selecting a value that provides the greatest level of available operating system security.

8. The method of claim 1, further comprising automatically generating a report that identifies the at least one configuration line item and the selected at least one value.

9. The method of claim 1:
wherein identifying at least one configuration line item comprises identifying a plurality of configuration line items, and generating the output comprises generating an output that automatically updates each of the plurality of configuration line items with a respective selected value;
further comprising generating a report that identifies configuration line items that are updated with selected values that are not equivalent to at least one corresponding recommended value.

10. A method of securing an operating system, comprising:
receiving a plurality of recommended values for a particular configuration line item of the operating system;
selecting a suitable one of the plurality of recommended values based on security implementation rules; and
generating an output that automatically updates the configuration line item with the selected value.

11. The method of claim 10, wherein selecting the suitable one of the recommended values comprises selecting a recommended value that is compatible with each of a plurality of applications to be instantiated on the operating system.

12. The method of claim 10, further comprising:
receiving at least one business security target that identifies at least one of the plurality of recommended values;
wherein selecting the suitable one of the plurality of recommended values comprises selecting the value that is identified by the business security target.

13. The method of claim 10, further comprising:
prioritizing a plurality of inputs providing the recommended values;
wherein selecting the suitable one of the plurality of recommended values comprises selecting a value recommended by at least one of the inputs having a highest priority.

14. The method of claim 10, wherein generating the output that automatically updates the configuration line item comprises generating at least one file selected from the group consisting of an information file and a data registry file.

15. The method of claim 10, wherein generating the output that automatically updates the configuration line item comprises processing the configuration line item and the selected value in accordance with an implementation rule corresponding to the operating system.

16. The method of claim 10, wherein generating the output that automatically updates the configuration line item comprises generating an executable file.

17. A program storage device readable by a machine, tangibly embodying a program of instructions executable by the machine to perform method steps for securing an operating system, said method steps comprising:
for a first application to be instantiated on the operating system, receiving from a first security template at least a first recommended value for a configuration line item;
for a second application to be instantiated on the operating system, receiving a second security template at least a second recommended value for the configuration line item;
from among at least the first and second values, automatically selecting at least one value that is compatible with each of the applications; and
generating an output that automatically updates the configuration line item with the selected at least one value.

18. The program storage device of claim 17, wherein generating the output that automatically updates the configuration line item comprises generating at least one file selected from the group consisting of an information file and a data registry file.

19. The program storage device of claim 17, wherein generating the output that automatically updates the configuration line item comprises processing implementation rules that provide syntax or data that correlates to updating the configuration line item with the selected value.

20. The program storage device of claim 17, said method steps further comprising generating a report that identifies the at least one configuration line item and the selected at least one value.
